(19) United States
(12) Patent Application Publication
(10) Pub. No.: US 2014/0380364 A1
(43) Pub. Date: Dec. 25, 2014

(54) METHODS AND SYSTEMS OF GENERATING A DISPLAY OF MEDIA LISTINGS IN DYNAMIC CELLS

(71) Applicant: United Video Properties, Inc., Santa Clara, CA (US)

(72) Inventor: Paul Jensen, Menlo Park, CA (US)

(73) Assignee: United Video Properties, Inc., Santa Clara, CA (US)

(21) Appl. No.: 13/923,576

(22) Filed: Jun. 21, 2013

(51) Int. Cl. H04N 21/482

(52) U.S. Cl. CPC H04N 21/482
USPC 725/44

(57) ABSTRACT

Methods and system are described for a media guidance application that generates a plurality of media cells, each corresponding to a particular media criterion, selects a plurality of media listings corresponding to the media criterion of each media cell, and automatically transitions between the media listings within the cell. For example, within each media cell, the media listings selected for that cell may crawl, one at a time, from one side of the media cell to the other. In another example, the media listings selected for each cell may automatically transition by displaying one media listing, removing the media listing, and displaying a different media listing in a continuous and/or repeating cycle.

### BACKGROUND OF THE INVENTION

In conventional systems, a user typically has many program choices available at any one time. As a user is unlikely to know the content of each program, program guides have been developed to present the available programs in an ordered manner. Typical program guides present available programs in a list or grid usually by the channel on which the program is being presented. As the number of channels or programs are too numerous to fit on any one screen, program guides typically allow a user to vertically scroll through different screens displaying the available programs or channels.

Vertically scrolling through multitudes of programs and channels is inherently slow. Moreover, as program guides typically sort the available program by numerical channel order, instead of by subject matter, programs of similar content are often placed sporadically throughout the program guide. Finally, users typically enjoy comparing available programs before selecting a program to watch; however, the sporadic placement of programs within the program guide, and the inefficiency of vertical scrolling, often make comparisons difficult.

In addition, program guides are frequently being applied to devices with smaller screens and input interfaces (e.g., mobile devices), as such navigation operations such as scrolling can become tedious (e.g., requiring repeated depressions of a directional arrow on a keypad, requiring continuous swipes in one direction on a touchscreen, etc.) or physically difficult (e.g., requiring precise inputs on a touchscreen to icons smaller than the typical finger of a user).

### SUMMARY

Accordingly, methods and systems are described herein for a media guidance application, which allows a user to more quickly and easily review, navigate, and select available media listings with limited scrolling. Specifically, the media guidance application generates a plurality of media cells, each corresponding to a particular media criterion (e.g., genre, transmission time, or content provider). The media guidance application then selects a plurality of media listings corresponding to the media criterion of each media cell and automatically transitions between the media listings within the cell. For example, within each media cell, the media listings selected for that cell may crawl, one at a time, from one side of the media cell to the other. In another example, the media listings selected for each cell may automatically transition by displaying one media listing, removing the media listing, and displaying a different media listing in a continuous and/or repeating cycle.

In some embodiments, a media guidance application generates a simultaneous display of a static cell that displays a media criterion and a dynamic cell that displays media listings corresponding to media criterion. The media guidance application may also select, based on the media criterion, media listings for display, one at a time, in the dynamic cell, automatically transitioning, at a regular interval, between the media listings, while the static content is maintained in the static cell. For example, if the media guidance application generates a plurality of dynamic cells and arranges the cells into a grid featuring a first axis, associated with the media criterion, and a second axis, associated with a different media criterion, the automatic transition of the media listings within each cell enables a user to minimize scrolling.

In some embodiments, the media guidance application may customize the display of media listings within each cell. For example, the media guidance application may generate a media asset (e.g., a preview, video clip, etc.), associated with the media listing currently displayed in the cell. The media guidance may also order and/or graphically accentuate a display of a first media listing relative to a display of a second media listing based on a comparison of characteristics associated with a media asset associated with each media listing and the media criterion.

In some embodiments, the media guidance application may also customize the transitions between media listings in each cell. For example, the media guidance application may determine a rate associated with automatically transitioning between a first media listing and a second media listing, and receive user inputs modifying the rate. In some embodiments, the rate may be based on a comparison of characteristics associated with a media asset associated with each media listing and the media criterion.

It should be noted, the systems and/or methods described above may be applied to, or used in accordance with, other systems and/or methods as described below.

### BRIEF DESCRIPTION OF DRAWINGS

The above and other objects and advantages of the disclosure will be apparent upon consideration of the following detailed description, taken in conjunction with the accompanying drawings, in which like reference characters refer to like parts throughout, and in which:

FIG. 1A shows an illustrative example of a media guidance application that may be used to display media listings and/or media assets in accordance with some embodiments of the disclosure;

FIG. 1B shows an illustrative example of a media guidance application that may be used to display media listings and/or media assets in dynamic cells in accordance with some embodiments of the disclosure;

FIG. 1C shows an illustrative example of a media guidance application in FIG. 1B after a dynamic cell has automatically transitioned in accordance with some embodiments of the disclosure;

FIG. 2A shows an illustrative example of a media guidance application that may be used to display media listings and/or media assets in dynamic cells arranged as a mosaic display in accordance with some embodiments of the disclosure;

FIG. 2B shows an illustrative example of a media guidance application in FIG. 2A after a dynamic cell has automatically transitioned in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A is an illustrative example of a dynamic cell before automatically transitioning in accordance with some embodiments of the disclosure;

FIG. 5B is an illustrative example of a dynamic cell as it automatically transitions in accordance with some embodiments of the disclosure;

FIG. 5C is an illustrative example of a dynamic cell after it has automatically transitioned in accordance with some embodiments of the disclosure;

FIG. 5D is an illustrative example of a dynamic cell after a user selection has caused a program selection screen to be displayed in accordance with some embodiments of the disclosure;

FIG. 6 is a flowchart of illustrative steps for generating a dynamic cell in accordance with some embodiments of the disclosure; and

FIG. 7 is a flowchart of illustrative steps for automatically transitioning between media listings in a dynamic cell in accordance with some embodiments of the disclosure.

### DETAILED DESCRIPTION

Methods and system are described herein for a media guidance application, which allows a user to more quickly and easily review, navigate, and select available media listings with limited scrolling. Specifically, the media guidance application generates a plurality of media cells, each corresponding to a particular media criterion. The media guidance application then selects a plurality of media listings corresponding to the media criterion of each media cell and automatically transitions between the media listings within the cell.

As used herein, a “media cell” or a “cell” refers to a distinct location on a display associated with particular media objects. The cell may be defined by a boundary that differentiates the area of the display associated with the particular media object from the area of the display not associated with the media object. The boundary may include, but is not limited to one or more sides. The cell may display media criterion and/or may display content associated with the media criterion.

A media cell may be static or dynamic. As used herein, a “dynamic cell” refers to a cell that includes media guidance data (e.g., media listings) that changes while media guidance data in other areas of a display is maintained. In some cases, a dynamic cell may include, but is not limited to, a cell that displays media guidance data that is automatically transitioning relative to media guidance data in a static cell. As used herein, a “static cell” refers to a cell that includes media guidance data that does not change while media guidance data in other areas of a display is changed. In some cases, a static cell may include, but is not limited to, a cell that displays media guidance data that is not automatically transitioning relative to the media guidance data in a dynamic cell.

As used herein, an “automatic transition” refers to a characteristic of a dynamic cell in which media guidance data changes without user input. In some cases, an automatic transition includes changing the display of media guidance data in a cell from media guidance data associated with a first media asset to media guidance data associated with a second media asset.

As used herein, a “media criterion” or “media criteria” refers to a standard, rule, or test on which a judgment or decision about media assets or media listings can be based. For example, in some embodiments, media criterion or media criteria may determine the media listings corresponding to a particular cell. The media criterion may be associated with and/or describe any characteristic of a media asset or media listing. For example, a media criterion may relate to media assets, media listings, and/or information related to media asset and/or listings such as broadcast times, broadcast channels, titles, content descriptions, related episodes, series information, ratings information (e.g., parental control ratings, critic's ratings, etc.), genre or category information, cast and crew information, media format (e.g., standard definition, high definition, 3D, etc.), advertisement information (e.g., advertisers or sponsors of a media asset), on-demand information, social media recommendations, user recommendations, price, website referrals, content, delivery type (e.g., broadcast, recorded, streaming, pay-per-view, on-demand), content provider, type of content provider (e.g., Internet, cable, etc.) and any other information that may describe a media asset or media listing.

It should be noted, that through this disclosure “media criterion” and “media criteria” may be used interchangeably. For example, a decision made based on a media criterion (e.g., genre) may equally be made to media criteria (e.g., genre and price). Likewise, a decision made based on a media criteria (e.g., transmission time, favorite actors of a user, media asset run-length) may equally be made to a media criterion (e.g., whether the media asset features interactive content).

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

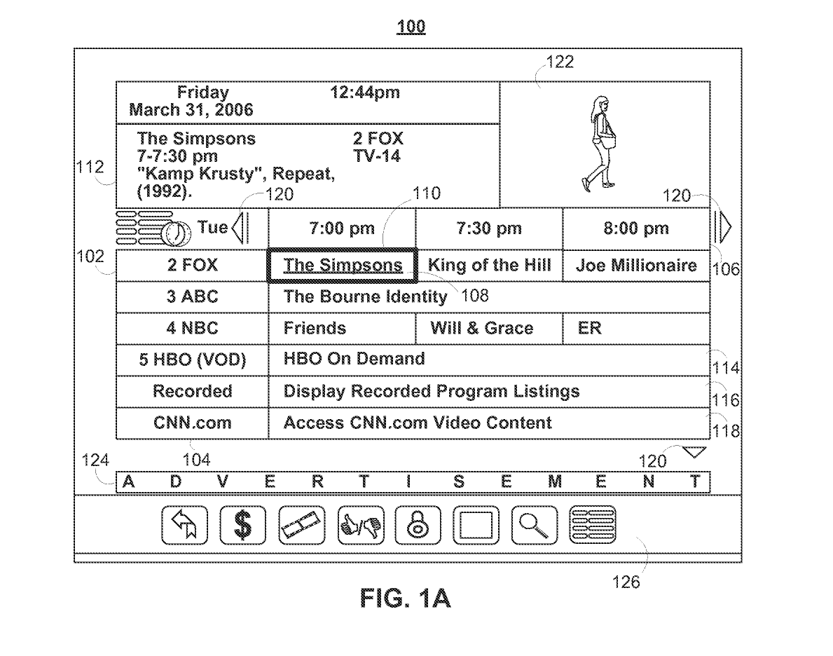

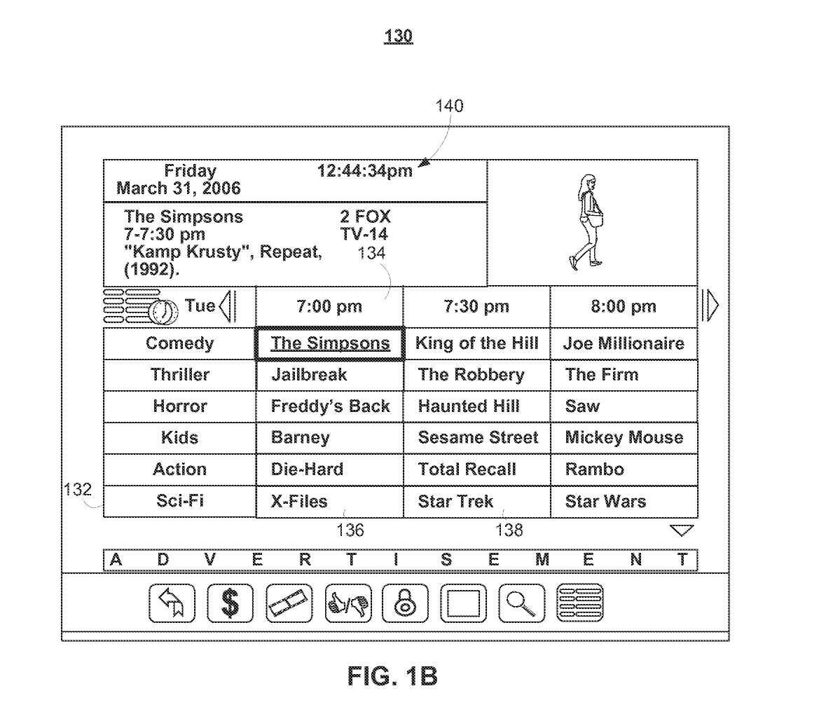

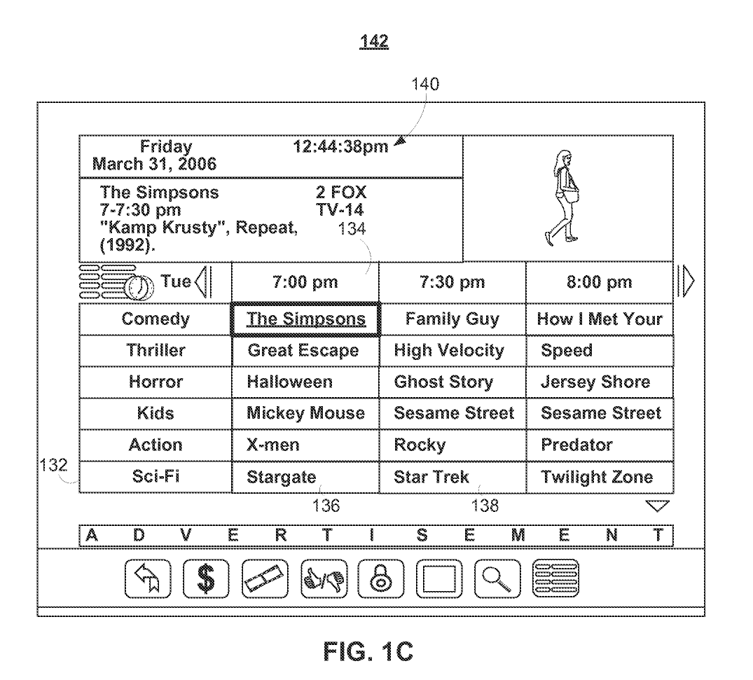

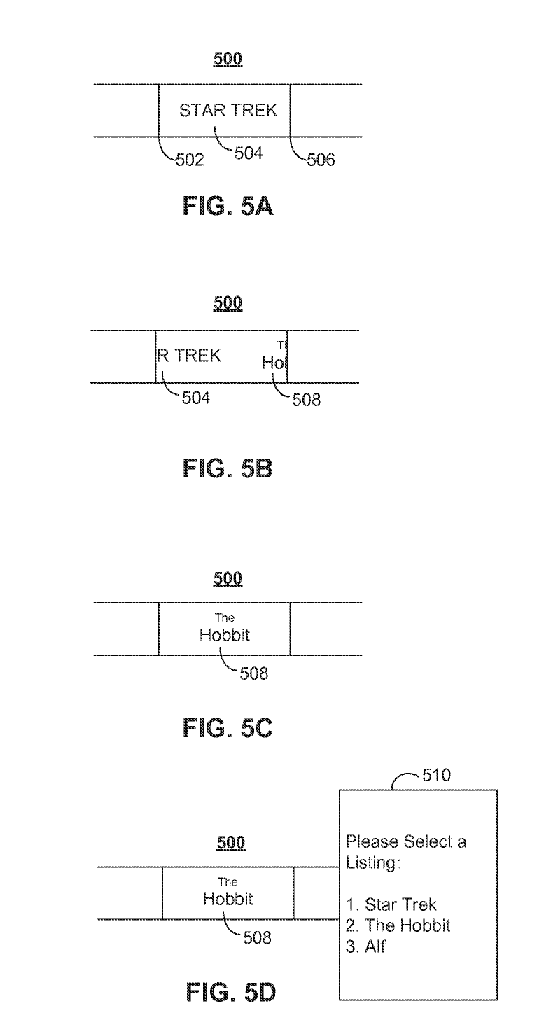

FIGS. 1A-C and 2A-B show illustrative display screens that may be used to provide media guidance data. The display screens shown in FIGS. 1A-C and 2A-B and the dynamic cells of FIGS. 5A-D may be implemented on any suitable user equipment device or platform. While the displays of FIGS. 1A-C and 2A-B are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1A shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

FIG. 1B shows an illustrative example of a media guidance application that may be used to display media listings and/or media assets in dynamic cells, and FIG. 1C shows an illustrative example of a media guidance application in FIG. 1B after a dynamic cell has automatically transitioned. FIG. 1B shows display 130. Display 130 includes several static cells (e.g., cells 132, 134, and 138) and a dynamic cell (e.g., cell 136).

In FIGS. 1B and 1C, a media guidance application has generated a simultaneous display of a static cell that displays a media criterion (e.g., cell 132) and a dynamic cell (e.g., cell 136) that displays media listings corresponding to media criterion. The media guidance application has also selected, based on the media criterion (e.g., science fiction programs), a media listing for display (e.g., “X-Files”) in the dynamic cell based on the media criterion (e.g., “X-Files” is associated with the science fiction genre).

In FIGS. 1B and 1C, the media guidance application generates a plurality of dynamic cells and arranges the cells into a grid featuring a first axis, associated with the media criterion (e.g., genre), and a second axis, associated with a different media criterion (e.g., transmission time). In FIGS. 1B and 1C a single media listing, corresponding to a single media asset is shown in each cell. The single media asset is associated with both the media criteria of the first and second axes. It should be noted that in some embodiments, multiple media listings may be displayed in each cell. For example, in some embodiments, each cell may show two media listings corresponding to the media criteria.

Display 130 of FIG. 1B also includes clock 140, which displays the current time (“12:44:34 pm”). In FIG. 1C, display 142 also includes clock 140. However, in FIG. 1C, clock 140 displays a different current time (“12:44:38 pm”), which is later than the current time of display 130 in FIG. 1B. Furthermore, cell 136, a dynamic cell, has automatically transitioned between the media listing shown in cell 136 of FIG. 1B to a different media listing in cell 136 of FIG. 1C, while the static cells (e.g., cells 132, 134, and 138) are maintained.

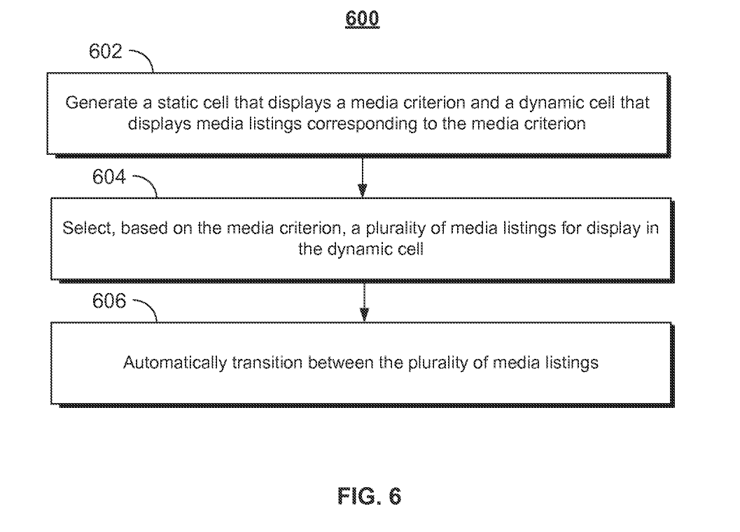

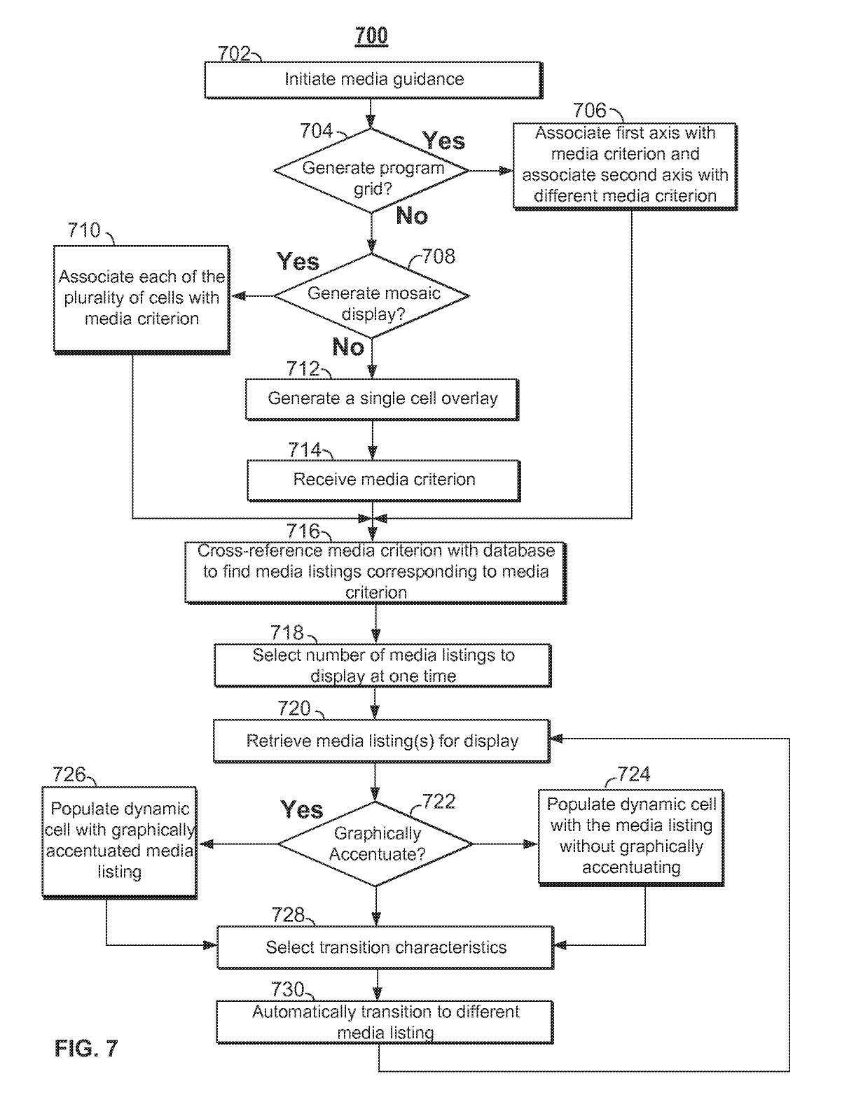

For example, while a user views display 130 of FIGS. 1B-C, the media guidance application may cycle through multiple media listings in cell 136. The media listings presented in cell 136 may correspond to media assets that match media criteria (e.g., as determined in relation to associated step 604 (FIG. 6) below). For example, the media listings cycled through in cell 136 may correspond to “Science Fiction” (as defined by cell 132) and a transmission time of “7:00 PM” (as defined by cell 134). In some embodiments, the number of media listings cycled through may correspond to the number of available media assets that match the media criteria. In some embodiments, the number of media listings may be limited to a particular number and/or modified based on additional criteria and/or user inputs as discussed in relation to FIG. 7 below.

While media listings are cycled through (e.g., in cell 136), different media listings may be shown in succession. After all available media listings or the available media listing that meet the media criteria associated with the dynamic cell are cycled through, the media guidance application may start the cycle over. Accordingly, in some embodiments, the media guidance application may show a continuous cycle of media listings, the last media asset in the cycle being followed by the first media asset in the cycle.

It should be noted that while the static cells (e.g., cells 132, 134, and 138) are all maintained, the static cells may be maintained for different reasons. For example, cells 132 and 143 display media criterion, not media listings, and therefore are not subject to an automatic transition. Cell 138, which does show media listings, is also maintained. In some embodiments, cell 138 may have been maintained because there were not any other media listings (and/or associated media assets) to automatically transition to that met by the media criterion.

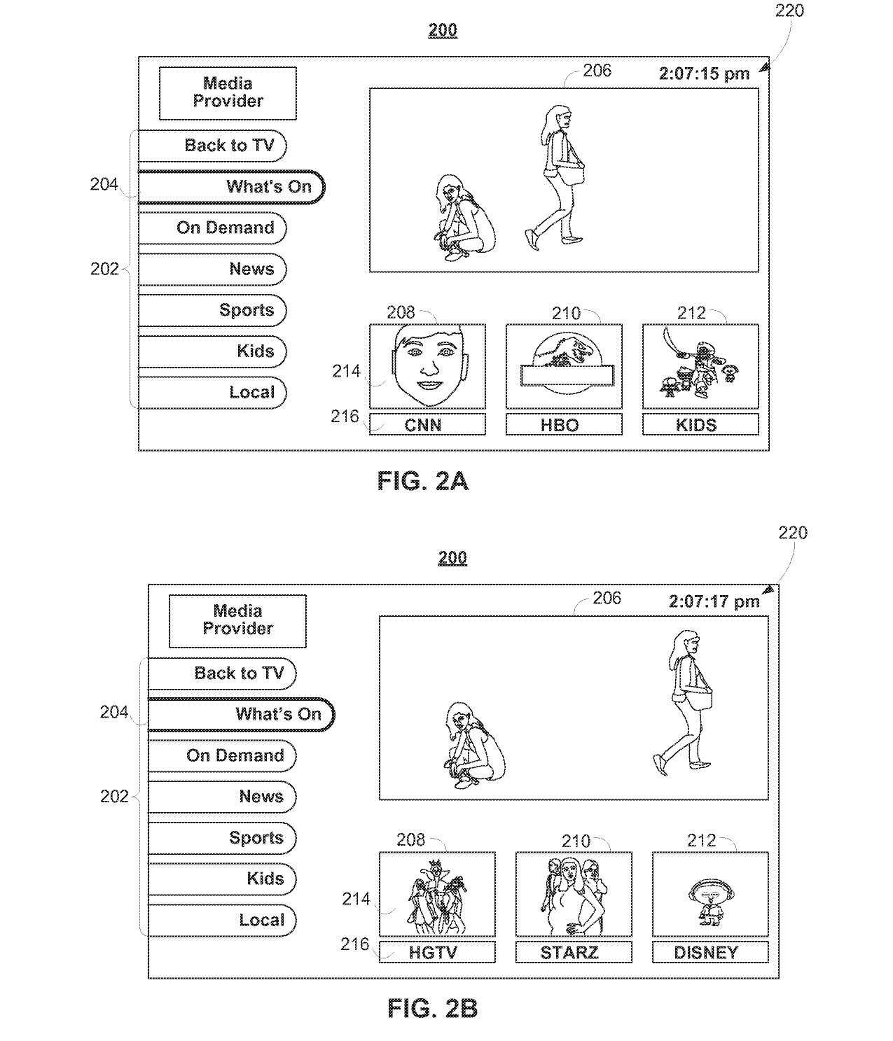

Another display arrangement for providing media guidance is shown in FIGS. 2A-B. In FIG. 2A, video mosaic display 200 includes selectable options 202 for content information organized based on content type, genre, and/or other organization criteria. In display 200, media listings option 204 is selected, thus providing media listings in cells 206, 208, 210, and 212. As shown in display 200, in some embodiments, the cells may provide graphical images including cover art, still images from the content, video clip previews, live video from the content, or other types of content that indicate to a user the content being described by the media guidance data in the cell. Each of the graphical listings may also be accompanied by text to provide further information about the content associated with the listing. For example, cell 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The cells in display 200 are of different sizes (i.e., cell 206 is larger than cells 208, 210, and 212), but if desired, all the cells may be the same size. Cells may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

In FIG. 2B, cells 208, 210, and 212 are dynamic cells and have automatically transitioned to display different program listings relative to cell 206, which continues to display the same program listing. As indicated by the disparity between clock 220 in FIGS. 2A and 2B, two seconds has elapsed. Cells 208, 210, and 212 now display different program listings corresponding to a media criterion or criteria.

In some embodiments, the cell of a mosaic display may be populated with media listings associated with media assets based on a comparison of the characteristics of the media asset with media criterion. For example, in some embodiments, the order of the media listings in the mosaic display may connate different levels of similarity or dissimilarity between a media asset and the media criterion. For example, media listings in cells further to the left may have characteristics that are more similar than media listings in cells further to the right.

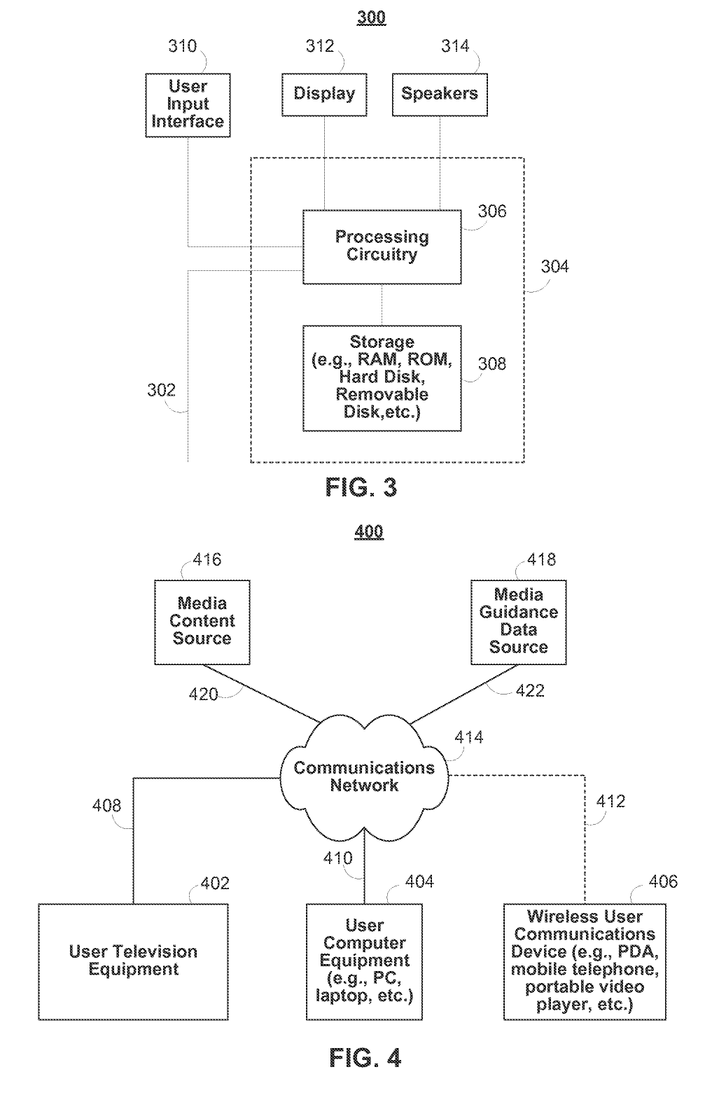

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIGS. 5A-D represent the various stages of dynamic cell 500 as it automatically transitions from displaying a first media listing to a second media listing. In FIG. 5A, a media guidance application displayed media guidance data in a cell before automatically transitioning to a different media guidance data. In FIG. 5A dynamic cell 500 currently displays media listing 504. Media listing 504 spans from first side 502 to second side 506 of dynamic cell 500. It should be noted that although dynamic cell 500 currently displays a title of media listing 504, any media guidance data could additionally or alternatively be displayed in dynamic cell 500.

In addition, it should be noted that although dynamic cell 500 is shown as a rectangle, dynamic cell 500 may be any shape, including, but not limited to, a circle, triangle, and/or polygon. In some embodiments, the shape of cell may also include rounded edges and/or vary in shape and/or size (e.g., as different media listing appear in the cell). The media guidance application may also customize cells to resemble a shape associated with the content currently displayed in the cell or resemble a shape associated with the media criteria associated with the cell.

FIG. 5B is an illustrative example of a dynamic cell as it automatically transitions. For example, dynamic cell 500 is transitioning by crawling (e.g., laterally translates) from first side 502 to second side 506. As media listing 504 crawls past first side 502, the portion of media listing 504 that is viewable is reduced. In FIG. 5B, media listing 504 is currently crawling “out” of dynamic cell 500, while media listing 508 is currently crawling “in” to dynamic cell 500. In this manner multiple listings can be displayed in the same dynamic cell without requiring a user to scroll or otherwise enter inputs.

It should be noted that multiple types of automatic transitions may be employed by the media guidance application. In some embodiments, a media listing may “flash” in dynamic cell 500. For example, the media guidance application may display the media listing, remove the media listing, and display a different media listing. Additionally or alternatively, the media guidance application may use various effects to transition from one media listing to a different media listing, including but not limited to, fades, dissolves, cascades, wipes, stripe and bar transitions, and/or any other animation effect.

FIG. 5C is an illustrative example of a dynamic cell after it has automatically transitioned. In dynamic cell 500 of FIG. 5C only media listing 508 is viewable. For example, dynamic cell 500 may represent the appearance of dynamic cell 500 of FIG. 5B after media listing 508 has been transitioned to. In some embodiments, a user may select media listings after they have been automatically transition to by the media guidance application. For example, after the media guidance application transitions to media listing 508, the media guidance application may receive a user input selecting media listing 508. In response to receiving the user input, the media guidance application may retrieve a media asset associated with media listing 508 and/or additional information about media listing 508 and/or the media asset associated with media listing 508.

Additionally or alternatively, receiving a user input may cause the media guidance application to generate selectable options of the plurality of media listings that are transitioned between in dynamic cell 500 as shown in FIG. 5D. In FIG. 5D, the media guidance application has generated selectable options 510, which provides a listing of the various media assets that a user may access. The order of the media listings in selectable options 510 may reflect the order that the media listings were displayed in dynamic cell 500.

FIG. 6 is a flowchart of illustrative steps for generating a dynamic cell. Process 600 may be used to generate the display screens in FIGS. 1A-C and 2A-B and/or the dynamic cell of FIGS. 5A-D. It should be noted that process 600 or any step thereof could be provided by any of the devices shown in FIGS. 3-4. For example, process 600 may be executed by control circuitry 304 (FIG. 3) as instructed by a media guidance application implemented on user equipment device 402, 404, and/or 406 (FIG. 4) to generate dynamic cell 500 (FIGS. 5A-D) into an interactive program guide (e.g., as shown in display 200 (FIG. 2A-B)) displayed on a display device (e.g., display 312 (FIG. 3)) accessible by the media guidance application.

At step 602, a media guidance application generates a static cell that displays a media criterion and a dynamic cell that displays media listings corresponding to the media criterion. For example, the media guidance application may generate a cell defining the media criterion (e.g., cell 132 (FIGS. 1B-C)) and a dynamic cell presenting one or more media listings that are associated with the media criterion (or are associated with a media asset that corresponds to the media criterion.

In some embodiments, the media guidance application generates (e.g., via control circuitry 304 (FIG. 3)) a plurality of media cells (e.g., cells 132 and 138 (FIGS. 1B-C)) each corresponding to a particular media criterion (e.g., genre, transmission time, or content provider). The media guidance application may generate a plurality of cells and arrange the cells into a grid (e.g., as shown in FIGS. 1A-C), which features a first axis, associated with a first media criterion (e.g., genre), and a second axis, associated with a different media criterion (e.g., transmission time). In some embodiments, the media guidance application may arrange the cells into a mosaic display (e.g., as shown in FIGS. 2A-B), which may not feature axes, but nonetheless arranges the cells according to a media criterion. For example, in a mosaic display, the cell may be listed according to particular criteria (e.g., genre, rating, subject matter, etc.) even though a corresponding cell does not identify the criteria as shown in FIGS. 2A-B.

At step 604, the media guidance application selects, based on the media criterion, a plurality of media listings for display in the dynamic cell. For example, as described below in step 716 (FIG. 7), the media guidance application may cross-reference a media criterion with a database of characteristics of media assets, for example, located locally (e.g., in storage 308 (FIG. 3) of user equipment device 402, 404, and/or 406 (FIG. 4)) or remotely (e.g., media guidance data source 418 (FIG. 4)), to find media listings corresponding to the media criterion. For example, the media guidance application may search media guidance data (e.g., a title, presentation time, etc.) describing a media asset to determine whether or not the media asset corresponds to a media criterion.

In some embodiments, the database may be structured as a look-up table. For example, the media guidance application may query (e.g., using control circuitry 304 (FIG. 3)) the database with the media criteria. The media guidance application may then filter the available media assets using each of the media criteria to find media assets corresponding to the media criteria. For example, if a media criterion in a content rating equal to or below PG-13, the media guidance application, may filter out available media assets with a content rating above PG-13.

The media guidance application may perform successive iterations of filtering in order to find media assets meeting the media criteria. In response, the media guidance application receives (e.g., via I/O path 302 (FIG. 3)) a list of the available media assets that meet the media criteria. The media guidance application may then generate media listings, based on the media assets meeting the media criteria, for display in a dynamic cell (e.g., dynamic cell 500 (FIG. 5A)).

In some embodiments, the media guidance application may determine the characteristic of a media asset by analyzing the content of available media assets. For example, the media guidance application may incorporate or have access to one or more content-recognition modules, which may be used by the media guidance application to analyze information received from a content capture device (e.g., video and/or audio recorder). For example, the media guidance application may include an object recognition module. The object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to determine the objects in and/or characteristics of video and audio content. For example, the media guidance application may receive a media asset in the form of a video (e.g., an audio/video recording of a user). The video may include a series of frames. For each frame of the video, the media guidance application may use an object recognition module to determine the content and context of a media asset for use in determining whether or not the media asset corresponds to a media criterion.

In some embodiments, the content-recognition module or algorithm may also include audio analysis and speech recognition techniques, including, but not limited to, Hidden Markov Models, dynamic time warping, and/or neural networks (as described above) to process audio data and/or translate spoken words into text. The content-recognition module may also use any other suitable techniques for processing audio and/or visual data. For example, the content-recognition module may analyze audio data to determine the content and context of a media asset for use in determining whether or not the media asset corresponds to a media criterion.

In addition, the media guidance application may use multiple types of optical character recognition and/or fuzzy logic, for example, when analyzing subtitles (e.g., in order to determine the circumstances and/or context of a media asset) or comparing multiple data fields (e.g., as contained in the described databases). For example, the media guidance application may arrange the text into data fields and cross-reference the data fields with other data fields (e.g., in a look-up table database). Using fuzzy logic, the system may determine two fields and/or values to be identical even though the substance of the data field or value (e.g., two different spellings) is not identical. In some embodiments, the system may analyze particular data fields of a database for particular values or text. Furthermore, the data fields may contain values (e.g., the data fields could be expressed in binary or any other suitable code or programming language) other than human-readable text. The media guidance application may interpret this information to determine whether or not the media asset corresponds to a media criterion.

At step 606, the media guidance application automatically transitions between the plurality of media listings. For example, within each media cell, the media listings selected for that cell may crawl, one at a time, from one side of the media cell to the other as shown and described in relation to FIGS. 5A-D. While the media listing is transitioning, the media guidance application may adjust various visual and audio characteristics of the media listings. For example, as discussed above, the media guidance application may automatically transition between media listings using fades, dissolves, cascades, wipes, stripe and bar transitions, and/or any other animation effect. Additionally or alternatively, the media guidance application may adjust the brightness, shape, size, or clarity of a media listing as it automatically transitions.

In some embodiments, in which the media listing is accompanied by audio information (e.g., a video clip or audio announcement of the name of the media listing), the media guidance application may adjust the volume of the audio information as the media guidance application automatically transitions. For example, in some embodiments, a video clip may accompany (or replace) a media listing in a dynamic cell (e.g., dynamic cell 500 (FIGS. 5A-D)). During the automatic transition, the volume of the video clip associated with the media listing being transitioned from may be reduced, while the volume of a video clip associated with a media listing being transitioned to may be increased.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method.

FIG. 7 is a flowchart of illustrative steps for automatically transitioning between media listings. Process 600 may be used to generate the display screens in FIGS. 1A-C and 2A-B and/or the dynamic cell of FIGS. 5A-D. It should be noted that process 600 or any step thereof could be provided by any of the devices shown in FIGS. 3-4. For example, process 600 may be executed by control circuitry 304 (FIG. 3) as instructed by a media guidance application implemented on user equipment device 402, 404, and/or 406 (FIG. 4) to generate dynamic cell 500 (FIGS. 5A-D) into an interactive program guide (e.g., as shown in display 200 (FIG. 2A-B)) displayed on a display device (e.g., display 312 (FIG. 3)) accessible by the media guidance application.

At step 702, the media guidance application initiates media guidance. For example, in some embodiments, the media guidance application may be initiated by turning on a user equipment device (e.g., user equipment device 402, 404, and/or 406 (FIG. 4)) upon which the media guidance application is implemented. Additionally or alternatively, the media guidance application may be initiated in response to a user input (e.g., selecting selectable option 204 (FIG. 2)).

At step 704, the media guidance application determines whether or not the media guidance provided will be in the form of a program grid. If so, the media guidance application associates a first axis with a first media criterion and associates a second axis with a second media criterion as step 706, before proceeding to step 716. For example, as shown in FIGS. 1B and 1C above, the media guidance application may generate (e.g., via control circuitry 304 (FIG. 3)) a plurality of dynamic cells and arrange the cells into a grid featuring a first axis, associated with the media criterion (e.g., genre), and a second axis, associated with a different media criterion (e.g., transmission time).

In some embodiments, the media criterion associated with each axis may be modified by a user. For example, a user may be able to select the particular media criterion for use in each axis. In addition, the media guidance application may store (e.g., on storage 308 (FIG. 3)) a user profile, which defines the media criterion that a user typically assigns to particular axes.

If the media guidance application determines not to provide the media guidance in the form of a program grid, the media guidance application proceeds to step 708, and determines whether or not to provide the media guidance in the form of a mosaic display. If so, the media guidance application associates each cell of a plurality of cells with a media criterion at step 710, before proceeding to step 716. For example, as shown and described above in FIGS. 2A-B, cells of a mosaic display may be populated with media listings associated with media assets based on a comparison of the characteristics of the media asset with media criterion. For example, in some embodiments, the order, size, and/or any graphical accentuation associated with a media cell may be reflective of different levels of similarity or dissimilarity between a media asset associated with a media listing and the media criterion. For example, media listings in cells displayed in larger, brighter cells may have characteristics that are more similar than media listings in cells displayed in smaller, darker cells.

If the media guidance application determines not to provide the media guidance in the form of a mosaic display, the media guidance application proceeds to step 712, and generates a single dynamic cell overlay. For example, in some embodiments, the media guidance application may generate a dynamic cell as an overlay or pop-up. While the overlay or pop-up may appear as a program grid (e.g., display 100 (FIG. 1A)) or a mosaic display (e.g., display 200 (FIG. 2A)), the overlay or pop-up may also appear as a single dynamic cell.

Following step 712, the media guidance application proceeds to step 714 and receives a media criterion. For example, the media guidance application may generate a single dynamic cell overlay in response to a user input (e.g., selecting selectable option 204 (FIG. 2A)). Additionally or alternatively, the media guidance application may prompt the user to provide a media criterion. In some embodiments, the media guidance application may store (e.g., in storage 308 (FIG. 3)) frequently used media criterion and/or criteria for use in generating a dynamic cell.

At step 716, the media guidance application cross-references the media criterion with a database to find media assets corresponding to the media criterion. For example, as described above in step 604 (FIG. 6), the media guidance application may cross-reference a media criterion with a database of characteristics of media assets, for example, located locally (e.g., in storage 308 (FIG. 3) of user equipment device 402, 404, and/or 406 (FIG. 4)) or remotely (e.g., media guidance data source 418 (FIG. 4)), to find media listings corresponding to the media criterion. For example, the media guidance application may search media guidance data (e.g., a title, presentation time, etc.) describing a media asset to determine whether or not the media asset corresponds to a media criterion.

In some embodiments, the media guidance application may determine a particular number of media listings to display in a given dynamic cell. For example, the number of media listings may correspond to the number of available media listings that meet the media criteria. In some embodiments, the media guidance application may limit the media listings that are displayed based on one or more additional criteria. For example, the media guidance application may limit the media listings that are displayed to a threshold number (e.g., based on processing power of the user device, the number of media listings that can be displayed in the dynamic cell in a particular period of time, the number of media listings a user is likely (e.g., based on a user profile or industry data) to watch automatically transition, etc.).

In some embodiments, the media guidance application may provide options for controlling the presentation of media listings in the dynamic cell. For example, the media guidance application may allow a user to pause, fast-forward, rewind, skip, etc. the media listings presented in a dynamic cell (e.g., cell 136 (FIG. 1B)). For example, the media guidance application may receive a user input selecting the cell. Upon selection, the user may request playback operations be performed via user inputs (e.g., enter via user input interface 310 (FIG. 3)). In response to the user input, the media guidance application may accelerate and/or decelerate the speed at which the media listings are automatically transitioned jump to a different media listing than the media listing currently displayed in the dynamic cell, etc. In addition, the media guidance application may generate pop-ups or overlays (e.g., selectable options 510 (FIG. 5D)), which may be used to select media listings for presentation, change the media criteria associated with a dynamic cell, graphically accentuate one or more media listings, and/or change the visual characteristics or transition characteristics of the dynamic cell (e.g., the size, shape, automatic transition speed, etc.).

At step 718, the media guidance application selects a number of media listings to display at one time in a dynamic cell. For example, the media guidance application may determine a maximum number of media listings that may be displayed at one time. In some embodiments, the maximum number of media listings displayed at one time may be a function of the size of the dynamic cell (e.g., dynamic cell 500 (FIG. 5)), the total number of dynamic cells in the display, the processing power of the user device (e.g., user equipment device (FIG. 3)), user preferences (e.g., as indicated by a profile stored in storage 308 (FIG. 3)), and/or any other suitable criteria. In some embodiments, the media guidance application may also prompt the user for a maximum number of media listings to display in a single dynamic cell.

At step 720, the media guidance application retrieves a media listing(s) for display in the dynamic cell. For example, the media guidance application may generate a first media listing (e.g., media listing 504 (FIG. 5A)) in a dynamic cell (e.g., dynamic cell 500 (FIG. 5A)) before automatically transitioning to a second media listing (e.g., media listing 508 (FIG. 5B)). In some embodiments, the media guidance application may determine an order for the display of the media listings. For example, the media guidance application may order the display of media listings based on the different levels of similarity or dissimilarity between a media asset associated with the media listing and the media criterion. In some embodiments, the order of the media listing may be reflective of a likelihood (e.g., based on a comparison with a user profile) that a user will enjoy the media asset associated with the media listing. For example, in addition to selecting media listings for display in a dynamic cell based on media criteria, the media guidance application may further order the media listings based on different factors that may or may not be the same as the media criteria.

At step 722, the media guidance application determines whether or not to graphically accentuate a media listing. For example, the media guidance application may modify the size, shape, brightness, color, and/or any other visual characteristic of a media listing relative to other media listings to indicate the different levels of similarity or dissimilarity between a media asset associated with the media listing and the media criterion. In some embodiments, similar to the order of the media listing described above, a graphically accentuated media listing may be reflective of a likelihood (e.g., based on a comparison with a user profile) that a user will enjoy the media asset associated with the media listing. For example, in addition to selecting media listings for display in a dynamic cell based on media criteria, the media guidance application may further graphically accentuate the media listings based on different factors that may or may not be the same as the media criteria.

If the media guidance application determines to graphically accentuate the media listings, the media guidance application populates the dynamic cell with a graphically accentuated media listing at step 726. If the media guidance application determines not to graphically accentuate the media listings, the media guidance application populates the dynamic cell with media listings without graphically accentuating any of the media listings at step 724.

At step 728, the media guidance application selects a transition characteristic for the automatic transition. For example, the media guidance application may select the type of transition (e.g., fades, dissolves, cascades, wipes, stripe and bar transitions, and/or any other animation effect), the speed of the transition (e.g., one second, two seconds, etc. between automatic transitions), and/or any other characteristic of the transition. In some embodiments, the media guidance application may also prompt the user to determine particular characteristics of the transition, and the selections of the user may be stored in a user profile (e.g., in storage 308 (FIG. 3)).

For example, the media guidance application may provide a menu (e.g., reachable via selectable options 202 (FIG. 2A)) from which the user may customize the presentation of cells, media listings within cells, and/or any other characteristic of the media guidance application. In some embodiments, the menu may appear as an overlay and/or upon a second device used to operate in concert with the device displaying the interactive program guide. For example, the media guidance application may receive a user input selecting the cell. Upon selection, the user may request a particular type of automatic transition, a particular length of an interval between two media listings, a speed associated with automatically transitioning through a cycle of media listing, and/or any other transition characteristic (e.g., enter via user input interface 310 (FIG. 3)). In response to the user input, the media guidance application may modify the presentation of the media listings as shown in the display (e.g., display 200 (FIG. 2A-B)). In addition, the media guidance application may generate pop-ups or overlays (e.g., selectable options 510 (FIG. 5D)), which may be used to select conditions or requirements for the presentation of media listings in a dynamic cell.

For example, the characteristic of the transition may be based on the media asset associated with the media listing currently displayed in the dynamic cell. In some embodiments, each cell of the plurality of cells may have transitions with different characteristics. In some embodiments, each media listing within a dynamic cell may exhibit different transition characteristics. For example, in some embodiments, the media guidance application may assign transition characteristics for each media listing based on the different levels of similarity or dissimilarity between a media asset associated with the media listing and the media criterion. Additionally or alternatively, the media guidance application may assign characteristics of the transition for each media listing based on a likelihood (e.g., based on a comparison with a user profile) that a user will enjoy or not enjoy the media asset associated with the media listing. For example, in addition to selecting media listings for display in a dynamic cell based on media criteria, the media guidance application may automatically transition from a media listing associated with a media asset that has a low likelihood of user interest faster than a media listing associated with a media asset that has a high likelihood of user interest.

Accordingly, the media guidance application may generate a display of an interactive program guide (e.g., as shown in FIGS. 1A-C). The interactive guide may simultaneously display multiple dynamic cells, each associated with different media criteria. Furthermore, the transitions characteristics of each of the dynamic cells may be different. Accordingly, the dynamic cells may both present different contain and automatically transition in different ways and at different rates.

At step 730, the media guidance application automatically transitions from the retrieve media asset and returns to step 720 to retrieve a different media asset. For example, as described in relation to step 606 (FIG. 6), the media guidance application (e.g., via control circuitry 304 (FIG. 3)) may crawl the media listings (e.g., as shown and described in relation to FIGS. 5A-D) across the dynamic cell (e.g., dynamic cell 500 (FIG. 5)). Additionally or alternatively, the media guidance application may adjust various visual and audio characteristics of the media listings. For example, as discussed above, the media guidance application may automatically transition between media listings using fades, dissolves, cascades, wipes, stripe and bar transitions, and/or any other animation effect. Additionally or alternatively, the media guidance application may adjust the brightness, shape, size, or clarity of a media listing as it automatically transitions.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method of generating a display of media listings, the method comprising:
generating a simultaneous display of a static cell and a dynamic cell, wherein the static cell displays a media criterion and the dynamic cell displays media listings corresponding to media criterion;
selecting, based on the media criterion, a plurality of media listings for display, one at a time, in the dynamic cell; and
automatically transitioning, at a regular interval, between a first media listing of the selected plurality of media listings and a second media listing of the selected plurality of media listings, while the static content is maintained in the static cell.

2. The method of claim 1, further comprising arranging a plurality of dynamic cells into a grid featuring a first axis, associated with the media criterion, and a second axis, associated with a different media criterion.

3. The method of claim 1, wherein automatically transitioning between the first media listing of the selected plurality of media listings and the second media listing of the selected plurality of media listings, comprises generating for display the first media listing, removing the first media listing, and generating for display the second media listing.

4. The method of claim 3, further comprising generating for display a media asset, associated with the first media listing, while the first media listing is generated for display.

5. The method of claim 1, further comprising:
defining a first side and a second side of the dynamic cell; and
crawling the first media listing from the first side to the second side of the dynamic cell.

6. The method of claim 1, further comprising graphically accentuating a display of the first media listing relative to a display of the second media listing based on a comparison of characteristics associated with a media asset associated with the first media listing and the media criterion.

7. The method of claim 1, further comprising:
determining a rate associated with automatically transitioning between the first media listing of the selected plurality of media listings and the second media listing of the selected plurality of media listings; and
receiving a user input modifying the rate.

8. The method of claim 1, further comprising generating additional information associated with the first media listing in response to receiving a user selection of the first media listing.

9. The method of claim 1, further comprising ordering the first media listing and the second media listing based on a comparison of characteristics associated with a media asset associated with the first media listing and the media criterion.

10. The method of claim 1, wherein the media criterion includes a genre, transmission time, or content provider.

11. A system for generating a display of media listings, the system comprising control circuitry configured to:
generate a simultaneous display of a static cell and a dynamic cell, wherein the static cell displays a media criterion and the dynamic cell displays media listings corresponding to media criterion;
select, based on the media criterion, a plurality of media listings for display, one at a time, in the dynamic cell; and
automatically transition, at a regular interval, between a first media listing of the selected plurality of media listings and a second media listing of the selected plurality of media listings, while the static content is maintained in the static cell.

12. The system of claim 11, wherein the control circuitry is further configured to arrange a plurality of dynamic cells into a grid featuring a first axis, associated with the media criterion, and a second axis, associated with a different media criterion.

13. The system of claim 11, wherein automatically transitioning between the first media listing of the selected plurality of media listings and the second media listing of the selected plurality of media listings, comprises generating for display the first media listing, removing the first media listing, and generating for display the second media listing.

14. The system of claim 13, wherein the control circuitry is further configured to generate for display a media asset, associated with the first media listing, while the first media listing is generated for display.

15. The system of claim 11, wherein the control circuitry is further configured to:
define a first side and a second side of the dynamic cell; and
crawl the first media listing from the first side to the second side of the dynamic cell.

16. The system of claim 11, wherein the control circuitry is further configured to graphically accentuate a display of the first media listing relative to a display of the second media listing based on a comparison of characteristics associated with a media asset associated with the first media listing and the media criterion.

17. The system of claim 11, wherein the control circuitry is further configured to:
determine a rate associated with automatically transitioning between the first media listing of the selected plurality of media listings and the second media listing of the selected plurality of media listings; and
receive a user input modifying the rate.

18. The system of claim 11, wherein the control circuitry is further configured to generate additional information associated with the first media listing in response to receiving a user selection of the first media listing.

19. The system of claim 11, wherein the control circuitry is further configured to order the first media listing and the second media listing based on a comparison of characteristics associated with a media asset associated with the first media listing and the media criterion.

20. The system of claim 11, wherein the media criterion includes a genre, transmission time, or content provider.

21-40. (canceled)
